(19) United States
(12) Patent Application Publication
(10) Pub. No.: US 2025/0138210 A1
(43) Pub. Date: May 1, 2025

(54) VIRTUAL ARRAYS FOR EARTHQUAKE EARLY WARNING SYSTEMS

(71) Applicant: SEISMICAI LTD, Tel Aviv-Jaffa (IL)

(72) Inventors: Alon ZIV, Tel Aviv (IL); Andreas Samuel EISERMANN, Hadera (IL); Omry VOLK, Jerusalem (IL)

(21) Appl. No.: 18/924,208

(22) Filed: Oct. 23, 2024

Related U.S. Application Data
(60) Provisional application No. 63/545,887, filed on Oct. 26, 2023.
(60) Provisional application No. 63/611,170, filed on Dec. 17, 2023.

(51) Int. Cl. G01V 1/30; G01V 1/18; G01V 1/34

(52) U.S. Cl. CPC G01V 1/305; G01V 1/18; G01V 1/306; G01V 1/34; G01V 2210/63

(57) ABSTRACT

Apparatus and methods are provided including a system that includes multiple seismic sensors and a processor. The processor receives respective seismograms from the seismic sensors during a seismic disturbance and identifies, based on the seismograms, respective estimated P-wave arrival times for at least some of the seismic sensors. Based on the estimated P-wave arrival times, the processor defines one or more virtual arrays, each of which includes at least three of the seismic sensors. The processor computes respective back azimuths for the virtual arrays, and based on the estimated P-wave arrival times and back azimuths, computes estimated coordinates of a focus of the seismic disturbance or of a point on a surface of Earth above the focus. The processor outputs an output based on the coordinates. Other applications are also described.

### CROSS-REFERENCE TO RELATED APPLICATIONS

The present application claims the benefit of U.S. Provisional Patent Application No. 63/545,887 to Ziv et al., filed Oct. 26, 2023, entitled “Methods and apparatus for earthquake early warning,” and U.S. Provisional Patent Application No. 63/611,170 to Ziv et al., filed Dec. 17, 2023, entitled “Virtual arrays for earthquake early warning systems,” which are incorporated herein by reference.

### FIELD OF THE INVENTION

Embodiments of the present invention are related generally to the field of seismology, and particularly to locating foci of seismic disturbances.

### BACKGROUND OF THE INVENTION

A seismic disturbance, such as an earthquake, causes the propagation of a P wave and a slower-moving S wave.

Regional earthquake early warning (EEW) systems run real-time algorithms that predict shaking intensity at target sites. Each such prediction depends on accurate, real-time estimates of the magnitude of the earthquake and the location of the hypocenter, or at least epicenter, of the earthquake. Errors in the estimate of hypocenter or epicenter location shift the locus of the shaking intensity map to an erroneous position, and also give rise to errors in the magnitude estimate.

A seismic array is a system of linked seismic sensors, which are typically arranged in a regular geometric pattern.

### SUMMARY OF THE INVENTION

Embodiments of the present invention include a system including multiple seismic sensors and a processor. The processor is configured to receive respective seismograms from the seismic sensors during a seismic disturbance, such as an earthquake, and to identify, based on the seismograms, respective estimated P-wave arrival times for at least some of the seismic sensors. Based on the estimated P-wave arrival times, the processor defines one or more virtual arrays, each of which includes at least three of the seismic sensors. Typically, the processor is configured to define the virtual arrays such that, for each of the virtual arrays, the respective estimated P-wave arrival times for the seismic sensors in the virtual array satisfy multiple constraints. The processor is further configured to compute respective back azimuths for the virtual arrays, and based on the estimated P-wave arrival times and back azimuths, to compute estimated coordinates of the focus of the seismic disturbance, such as the hypocenter of an earthquake, or of a point on the surface of the Earth above the focus, such as the epicenter of an earthquake. The processor is further configured to output an output based on the coordinates.

Embodiments of the present invention further include a system including multiple seismic sensors and a processor. The processor is configured to receive respective seismograms from the seismic sensors during a seismic disturbance, such as an earthquake, and to identify, based on the seismograms, respective estimated P-wave arrival times for at least some of the seismic sensors. Based on the estimated P-wave arrival times, the processor computes respective back azimuths for one or more virtual or non-virtual arrays of the seismic sensors. The processor is further configured to identify, based on the seismograms, respective estimated S-wave arrival times for at least some of the arrays. The processor is further configured to compute estimated coordinates of the focus of the seismic disturbance, such as the hypocenter of an earthquake, or of a point on the surface of the Earth above the focus, such as the epicenter of an earthquake, based on the estimated P-wave arrival times, back azimuths, and estimated S-wave arrival times, and to output an output based on the coordinates.

There is therefore provided, in accordance with some embodiments of the present invention, a system including multiple seismic sensors and a processor. The processor is configured to receive respective seismograms from the seismic sensors during a seismic disturbance, to identify, based on the seismograms, respective estimated P-wave arrival times for at least some of the seismic sensors, to define one or more virtual arrays, each of which includes at least three of the seismic sensors, based on the estimated P-wave arrival times, to compute respective back azimuths for the virtual arrays, to compute estimated coordinates of a focus of the seismic disturbance or of a point on a surface of Earth above the focus, based on the estimated P-wave arrival times and back azimuths, and to output an output based on the coordinates.

In some embodiments, the seismic disturbance is an earthquake, and the focus is a hypocenter of the earthquake.

In some embodiments, the processor is configured to define at least one of the virtual arrays before one or more of the estimated P-wave arrival times.

In some embodiments, the processor is configured to compute the estimated coordinates in response to defining a predefined maximum number of the virtual arrays, the maximum number being greater than one.

In some embodiments, the processor is configured to compute the estimated coordinates by minimizing a cost function that is based on the estimated P-wave arrival times and back azimuths.

In some embodiments, the processor is further configured to compute respective slowness vectors for the virtual arrays based on the estimated P-wave arrival times, and the processor is configured to compute the back azimuths based on the slowness vectors.

In some embodiments, the processor is configured to compute the estimated coordinates based on respective magnitudes of the slowness vectors.

In some embodiments, the processor is further configured to identify, based on the seismograms, respective estimated S-wave arrival times for at least some of the virtual arrays, and the processor is configured to compute the estimated coordinates based on the estimated S-wave arrival times.

In some embodiments, the processor is configured to define the virtual arrays such that, for each of the virtual arrays, the respective estimated P-wave arrival times for the seismic sensors in the virtual array satisfy multiple constraints.

In some embodiments, the constraints include a stability constraint, which requires that a solution to an equation for calculating a slowness vector based on the respective estimated P-wave arrival times for the seismic sensors in the virtual array have a predefined degree of stability.

In some embodiments,
N is a number of the seismic sensors in the virtual array,
Δt₁ⱼ^{P} is a difference between the estimated P-wave arrival time for a j^{th} one of the seismic sensors in the virtual array and the estimated P-wave arrival time for a first one of the seismic sensors in the virtual array, for j=2 . . . N,

\vec{Δt^{P}}=(Δt₁₂^{P}, . . . ,Δt_{1N}^{P})^{T},
x₁ⱼ^{e} and x₁ⱼⁿ are respective distances, along mutually-perpendicular axes, between the j^{th} one of the seismic sensors in the virtual array and the first one of the seismic sensors in the virtual array, for j=2 . . . N,

$$X = ( \begin{matrix}{x}_{12}^{e} & {x}_{12}^{n} \\ ⋮ & ⋮ \\ {x}_{1 N}^{e} & {x}_{1 N}^{n}\end{matrix} ) ,$$

the equation is \vec{s}=(X^{T}X)⁻¹X^{T}\vec{Δt^{P}}.

In some embodiments,
λ₁ and λ₂ are largest and smallest eigenvalues of X^{T}X, respectively, and
the stability constraint requires that

$$( \frac{{λ}_{2}}{{λ}_{1}} )$$

exceed a predefined threshold.

In some embodiments,
N is a number of the seismic sensors in the virtual array,
Δtᵢⱼ^{P} is a difference between the estimated P-wave arrival time for a j^{th} one of the seismic sensors in the virtual array and the estimated P-wave arrival time for an i^{th} one of the seismic sensors in the virtual array, for i=1 . . . N and j=1 . . . N,
rᵢⱼ is a horizontal distance between the j^{th} one of the seismic sensors in the virtual array and the i^{th} one of the seismic sensors in the virtual array,
α is an upper-crust P-wave speed, and
the constraints include an inter-sensor delay constraint, which requires that <tᵢⱼ<rᵢⱼ/α for all i≠j.

In some embodiments, the constraints include an external-location constraint, which requires that preliminary estimated coordinates of the point above the focus, which are estimated based on the respective estimated P-wave arrival times for the seismic sensors in the virtual array, lie outside a perimeter of the virtual array.

There is further provided, in accordance with some embodiments of the present invention, a method including receiving multiple seismograms from respective seismic sensors during a seismic disturbance, identifying, based on the seismograms, respective estimated P-wave arrival times for at least some of the seismic sensors, based on the estimated P-wave arrival times, defining one or more virtual arrays, each of which includes at least three of the seismic sensors, computing respective back azimuths for the virtual arrays, based on the estimated P-wave arrival times and back azimuths, computing estimated coordinates of a focus of the seismic disturbance or of a point on a surface of Earth above the focus, and outputting an output based on the coordinates.

There is further provided, in accordance with some embodiments of the present invention, a computer software product including a tangible non-transitory computer-readable medium in which program instructions are stored. The instructions, when read by a processor, cause the processor to receive multiple seismograms from respective seismic sensors during a seismic disturbance, to identify, based on the seismograms, respective estimated P-wave arrival times for at least some of the seismic sensors, to define one or more virtual arrays, each of which includes at least three of the seismic sensors, based on the estimated P-wave arrival times, to compute respective back azimuths for the virtual arrays, to compute estimated coordinates of a focus of the seismic disturbance or of a point on a surface of Earth above the focus based on the estimated P-wave arrival times and back azimuths, and to output an output based on the coordinates.

There is further provided, in accordance with some embodiments of the present invention, a system including multiple seismic sensors and a processor. The processor is configured to receive respective seismograms from the seismic sensors during a seismic disturbance, to identify, based on the seismograms, respective estimated P-wave arrival times for at least some of the seismic sensors, to compute respective back azimuths for one or more arrays of the seismic sensors, based on the estimated P-wave arrival times, to identify, based on the seismograms, respective estimated S-wave arrival times for at least some of the arrays, to compute estimated coordinates of a focus of the seismic disturbance or of a point on a surface of Earth above the focus, based on the estimated P-wave arrival times, back azimuths, and estimated S-wave arrival times, and to output an output based on the coordinates.

In some embodiments, the seismic disturbance is an earthquake, and the focus is a hypocenter of the earthquake.

In some embodiments, the processor is configured to compute the estimated coordinates by minimizing a cost function that is based on the estimated P-wave arrival times, back azimuths, and estimated S-wave arrival times.

In some embodiments, the processor is further configured to compute respective slowness vectors for the arrays based on the estimated P-wave arrival times, and the processor is configured to compute the back azimuths based on the slowness vectors.

In some embodiments, the processor is configured to compute the estimated coordinates based on respective magnitudes of the slowness vectors.

In some embodiments, the processor is configured to identify the estimated S-wave arrival time for each of the at least some of the arrays by:
by applying a short-term to long-term average ratio filter to respective horizontal magnitudes of those of the seismograms recorded by the array, calculating a filtered signal yⱼ^{h}*(t) for each j^{th} one of the sensors in the array,
by applying a short-term to long-term average ratio filter to respective vertical magnitudes of those of the seismograms recorded by the array, calculating another filtered signal yⱼ^{v}*(t) for each j^{th} one of the sensors in the array,
for each j^{th} one of the sensors in the array, calculating an expected difference Δt₁ⱼ^{S} between an S-wave arrival time at the j^{th} sensor and the S-wave arrival time at a first one of the sensors in the array,
computing a horizontal beam B^{h}(t)=Σⱼ₌₁^{N}yⱼ^{h}*(t+Δt₁ⱼ^{S}), N being a number of the sensors in the array,
computing a horizontal-to-vertical-ratio beam

$${B}^{h 2 v} ( t ) = \frac{1}{N} {\sum }_{j = 1}^{N} \frac{{y}_{j}^{h *} ( t + Δ {t}_{1 j}^{S} )}{{y}_{j}^{v *} ( t + Δ {t}_{1 j}^{S} )} ,$$

and
identifying the estimated S-wave arrival time for the array in response to a time at which B^{h}(t) and B^{h2v}(t) exceed respective thresholds.

In some embodiments, the processor is configured to identify the estimated S-wave arrival time as the time at which B^{h}(t) and B^{h2v}(t) exceed the respective thresholds.

In some embodiments, the processor is configured to identify the estimated S-wave arrival time by:
based on the time at which B^{h} (t) and B^{h2v}(t) exceed the respective thresholds and on the expected difference Δt₁ⱼ^{S} for j=2 . . . N, calculating an average S-wave arrival time for the array, and
identifying the estimated S-wave arrival time as the average S-wave arrival time.

There is further provided, in accordance with some embodiments of the present invention, a method, including receiving multiple seismograms from respective seismic sensors during a seismic disturbance, identifying, based on the seismograms, respective estimated P-wave arrival times for at least some of the seismic sensors, based on the estimated P-wave arrival times, computing respective back azimuths for one or more arrays of the seismic sensors, identifying, based on the seismograms, respective estimated S-wave arrival times for at least some of the arrays, based on the estimated P-wave arrival times, back azimuths, and estimated S-wave arrival times, computing estimated coordinates of a focus of the seismic disturbance or of a point on a surface of Earth above the focus, and outputting an output based on the coordinates.

There is further provided, in accordance with some embodiments of the present invention, a computer software product including a tangible non-transitory computer-readable medium in which program instructions are stored. The instructions, when read by a processor, cause the processor to receive multiple seismograms from respective seismic sensors during a seismic disturbance, to identify, based on the seismograms, respective estimated P-wave arrival times for at least some of the seismic sensors, to compute respective back azimuths for one or more arrays of the seismic sensors, based on the estimated P-wave arrival times, to identify, based on the seismograms, respective estimated S-wave arrival times for at least some of the arrays, to compute estimated coordinates of a focus of the seismic disturbance or of a point on a surface of Earth above the focus, based on the estimated P-wave arrival times, back azimuths, and estimated S-wave arrival times, and to output an output based on the coordinates.

The present invention will be more fully understood from the following detailed description of embodiments thereof, taken together with the drawings, in which:

### BRIEF DESCRIPTION OF THE DRAWINGS

FIG. 1 is a schematic illustration of a system for locating a focus of a seismic disturbance, in accordance with some embodiments of the present invention;

FIG. 2 is a flow diagram for a method for computing estimated focal coordinates, in accordance with some embodiments of the present invention; and

FIG. 3 is a flow diagram for an example algorithm for defining virtual arrays, in accordance with some embodiments of the present invention.

### DETAILED DESCRIPTION

### Overview

Offshore earthquakes, similarly to other off-network earthquakes, present a serious challenge for regional EEW systems utilizing standard seismic networks, due to the difficulty in locating the hypocenter, or at least epicenter, of the earthquake in real-time. Although some ocean-bottom networks have been deployed or at least considered, the use of ocean-bottom networks is typically not feasible.

To address this challenge, embodiments of the present invention provide a system configured to locate offshore (and off-network) hypocenters or epicenters accurately and in real-time, using standard seismic networks. The system makes use of one or more virtual arrays, which are groups of seismic sensors that are not designated as arrays in advance, as is done in some non-standard seismic networks, but rather, are designated in real-time, based on the P-wave arrival times, i.e., the estimated times at which the P wave reached the seismic sensors of the network. For example, the sensors of each virtual array are not necessarily linked or arranged in a regular geometric pattern. Embodiments of the present invention further provide techniques for designating the virtual arrays.

More specifically, many conventional EEW systems, which lack arrays, have only the estimated P-wave arrival times with which to work; hence, these systems locate the hypocenter or epicenter with only limited accuracy. On the other hand, per embodiments of the present invention, each virtual array provides additional parameters, which facilitate a more accurate location. In some embodiments, these additional parameters include a back azimuth, a slowness magnitude, and/or, in some cases, an estimated S-wave arrival time, which may be defined as the average time at which the S wave reached the seismic sensors of the array.

Furthermore, even conventional EEW systems that include predesignated (non-virtual) arrays of seismic sensors do not utilize the estimated S-wave arrival time, due to the challenge in calculating this parameter. On the other hand, embodiments of the present invention provide methods for efficiently calculating this parameter, such that this parameter can be used to boost the location accuracy even in such conventional EEW systems.

In addition to earthquakes, embodiments of the present invention may be applied to any other type of seismic disturbance, such as the digging of a tunnel.

### System Description

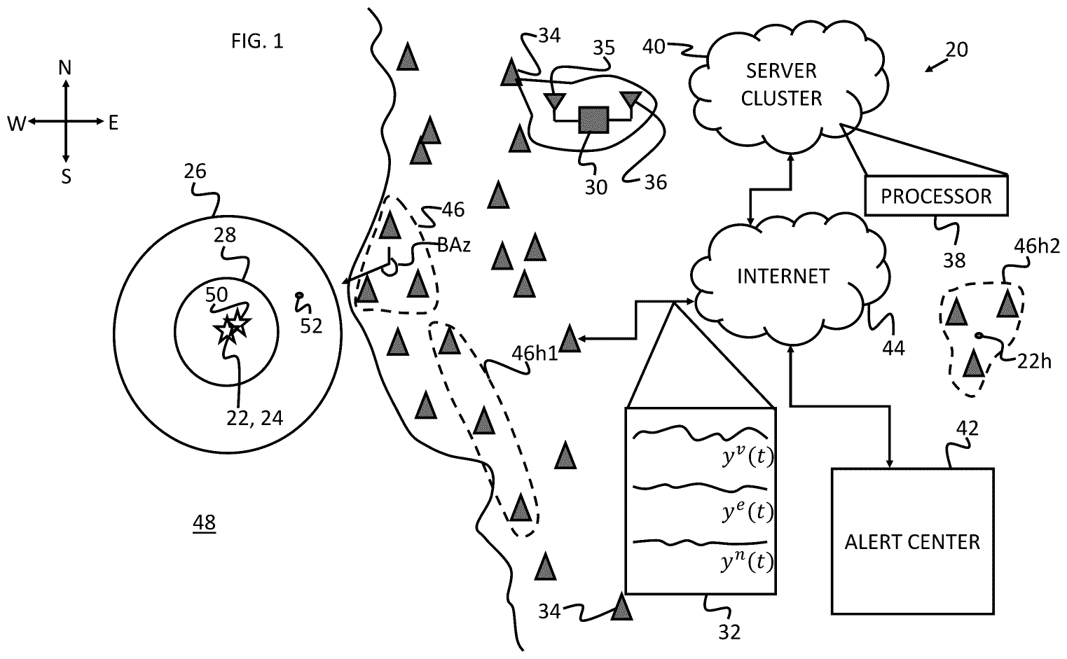

Reference is initially made to FIG. 1, which is a schematic illustration of a system 20 for computing estimated coordinates 50 of a focus 22 of a seismic disturbance, such as the hypocenter 24 of an earthquake, or of a point on the Earth's surface above focus 22, such as the epicenter of an earthquake, in accordance with some embodiments of the present invention. In the example scenario depicted in FIG. 1, an offshore earthquake, i.e., an earthquake under water 48, has occurred, such that hypocenter 24 is beneath the seabed and the epicenter is above the hypocenter at the surface of water 48. FIG. 1 shows the wavefront 26 of the resulting P wave and the wavefront 28 of the slower-travelling S wave.

System 20 comprises a network of seismic sensors 30, which may also be referred to as “seismographs” or “seismometers,” and at least one computer processor 38.

Each seismic sensor 30 is configured to record a seismogram 32, which typically includes three components: a vertical component y^{v}(t), which measures vertical tremors in the Earth, and two additional components y^{e}(t) and yⁿ(t) that measure horizontal tremors along two mutually-perpendicular axes. Typically, these two axes are the east-west axis (hence, the superscript “e”) and the north-south axis (hence, the superscript “n”). Each seismogram data point thus includes respective values, at a particular point in time, for y^{v}(t), y^{e}(t), and yⁿ(t). In some embodiments, the sampling frequency of each sensor 30 is around 100 Hz, i.e., around 100 data points are acquired per second.

Each sensor is further configured to communicate seismogram 32 to processor 38 for processing. For example, as illustrated in FIG. 1, the sensor may communicate the seismogram over the Internet 44. Alternatively or additionally, the sensor may communicate the seismogram over radio, a cellular network, or any other communication medium. Typically, the sensor communicates each new seismogram data point, or each new series of consecutive data points (spanning several seconds, for example), immediately after the acquisition of the data point(s), such that processor 38 receives the data points in near real-time. Based on seismograms 32, processor 38 computes estimated coordinates 50, as described in detail below with reference to the subsequent figures.

Typically, each seismic sensor 30 belongs to a seismic station 34, which typically includes one or more additional components such as a power source (not shown), a global positioning system (GPS) antenna 35, which is used for timestamping the seismogram data points, and/or a communication interface 36, such as an antenna, which is used for communicating the seismograms. Typically, each station 34 is located on land, e.g., near the coast, rather than under water 48.

In some embodiments, processor 38 is embodied as a single processor, which may belong, for example, to a server cluster 40 or to an alert center 42, such as an EEW system alert center. In other embodiments, processor 38 is embodied as a cooperatively networked or clustered set of processors, i.e., the functionality of processor 38, as described herein, is performed cooperatively by multiple processors. In some such embodiments, the set of processors belongs to server cluster 40 and/or alert center 42.

The functionality of processor 38 may be implemented solely in hardware, e.g., using one or more fixed-function or general-purpose integrated circuits, Application-Specific Integrated Circuits (ASICs), and/or Field-Programmable Gate Arrays (FPGAs). Alternatively, this functionality may be implemented at least partly in software. For example, the processor may be embodied as a programmed processor comprising, for example, a central processing unit (CPU) and/or a Graphics Processing Unit (GPU). Program code, including software programs, and/or data may be loaded for execution and processing by the CPU and/or GPU. The program code and/or data may be downloaded to the processor in electronic form, over a network, for example. Alternatively or additionally, the program code and/or data may be provided and/or stored on non-transitory tangible media, such as magnetic, optical, or electronic memory. Such program code and/or data, when provided to the processor, produce a machine or special-purpose computer, configured to perform the tasks described herein.

### Computing Estimated Coordinates

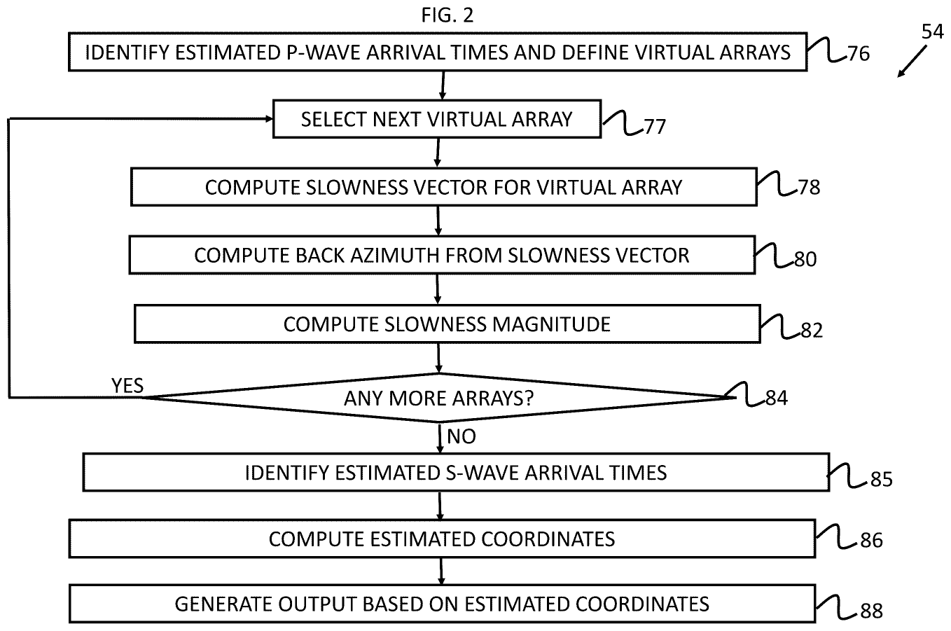

Reference is now additionally made to FIG. 2, which is a flow diagram for a method 54 for computing estimated coordinates 50, in accordance with some embodiments of the present invention.

Method 54 begins with a first step 76, at which processor 38 identifies, based on the seismograms received from seismic sensors 30, respective estimated P-wave arrival times for at least some of the seismic sensors, these sensors being referred to below as “triggered” sensors. In other words, for each triggered sensor, processor 38 estimates the time at which wavefront 26 reached the sensor.

For example, for each received seismogram, the processor may apply a short-term to long-term average ratio (STA/LTA) filter to the vertical component y^{v}(t) of the seismogram. The processor may then identify the estimated P-wave arrival time as a time at which the filtered vertical component exceeds (e.g., the first time at which the filtered vertical component exceeds) a predefined threshold.

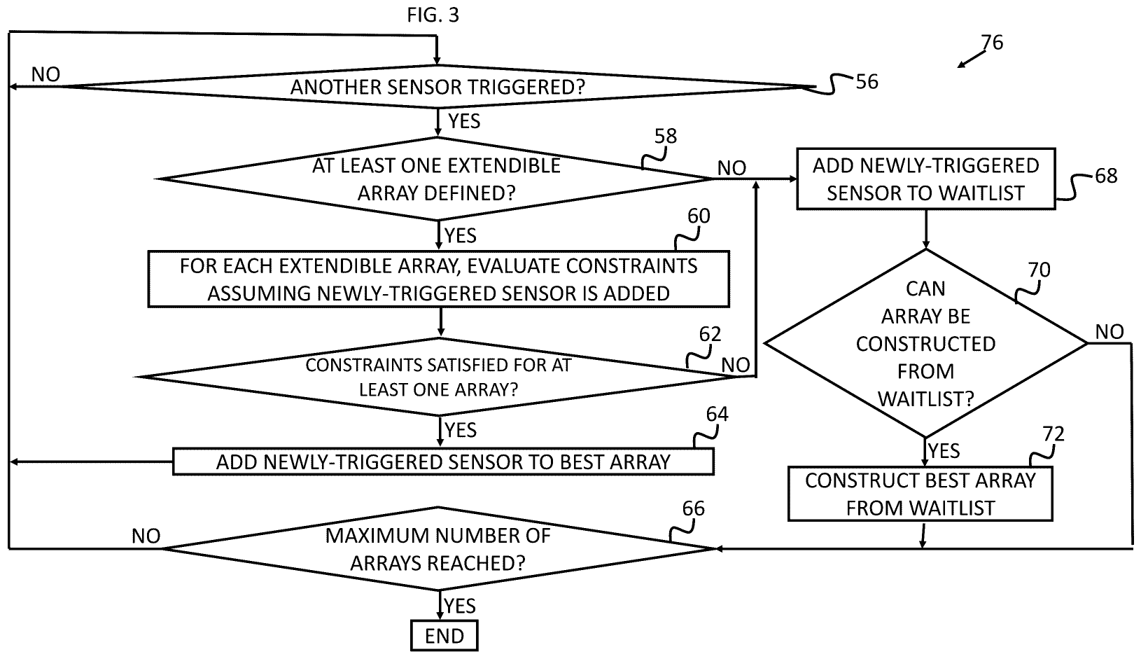

In addition, at first step 76, based on the estimated P-wave arrival times, the processor defines one or more virtual arrays 46, each of which includes at least three of the seismic sensors. Typically, virtual arrays 46 are defined such that, for each of the virtual arrays, the respective estimated P-wave arrival times for the seismic sensors in the virtual array satisfy multiple constraints, as further described below with reference to FIG. 3.

Next, the processor selects one of the virtual arrays at an array-selecting step 77. The processor then computes a back azimuth BAz for the selected array, at a back-azimuth-computing step 80. As illustrated in FIG. 1, each back azimuth is the angle, typically defined with respect to the north-south axis, of a horizontal vector pointing from the centroid of the array in the direction of the focus of the seismic disturbance. Since the computation of the back azimuth requires at least three estimated P-wave arrival times, each virtual array includes at least three sensors, as noted above.

Typically, to compute the back azimuth, the processor first computes a slowness vector \vec{s}==(s^{e}, sⁿ)^{T} for the virtual array based on the P-wave arrival times, at a slowness-vector-computing step 78. Each component of the slowness vector is the estimated slowness, i.e., the inverse of the estimated speed, of the P wave along one of the perpendicular axes; for example, s^{e} may be the slowness along the east-west axis, and sⁿ may be the slowness along the north-south axis. Next, at back-azimuth-computing step 80, the processor computes the back azimuth from the slowness vector, as atan(s^{e}/sⁿ).

In some embodiments, the slowness vector is computed as follows:
First, the processor designates any one of the seismic sensors in the virtual array as the “first” sensor in the array, i.e., the sensor with respect to which inter-sensor distances and inter-sensor times are to be calculated. The processor then constructs the matrix X=

$$( \begin{matrix}{x}_{12}^{e} & {x}_{12}^{n} \\ ⋮ & ⋮ \\ {x}_{1 N}^{e} & {x}_{1 N}^{n}\end{matrix} ) ,$$

where:
N is the number of seismic sensors in the virtual array, and
x₁ⱼ^{e} and x₁ⱼⁿ are respective distances, along the mutually-perpendicular axes of the seismogram (e.g., the east-west and north-south axes), between the j^{th} seismic sensor in the virtual array and the first seismic sensor in the virtual array, for j=2 . . . N. (More generally, xᵢⱼ^{e} and xᵢⱼⁿ are respective distances, along the mutually-perpendicular axes of the seismogram, between the i^{th} and j^{th} seismic sensors in the virtual array, for i=1 . . . N and j=1 . . . N.)
Next, the processor solves the equation X\vec{s}=\vec{Δt^{P}} for the slowness vector \vec{s}=(s^{e},sⁿ)^{T}, where \vec{Δt^{P}}=(Δt₁₂^{P}, . . . , Δt_{1N}^{P})^{T}, Δt₁ⱼ^{P} being the inter-sensor P-wave delay between the first and j^{th} sensors of the array, i.e., the difference between the estimated P-wave arrival time at the j^{th} sensor of the array, j=2 . . . N, and the estimated P-wave arrival time at the first sensor of the array. (More generally, Δtᵢⱼ^{P} is the inter-sensor P-wave delay between the i^{th} and j^{th} sensors of the array, for i=1 . . . N and j=1 . . . N.) For example, the processor may compute the slowness vector as \vec{s}=(X^{T}X)⁻¹X^{T}\vec{Δt^{P}}, where X^{T} is the transpose of X.

Typically, the processor also computes the magnitude SLO=\sqrt{s^{e}^{²}+sⁿ^{²}} of the slowness vector, at a magnitude-computing step 82.

After computing the back azimuth and, optionally, the slowness magnitude, the processor checks, at a checking step 84, whether any more virtual arrays remain to be selected. If yes, the processor returns to array-selecting step 77 and selects the next array. Otherwise, the processor proceeds to compute estimated coordinates 50 at a coordinate-computing step 86.

In some embodiments, prior to computing the estimated coordinates, the processor performs an S-wave-picking step 85 at which the processor identifies, based on the seismograms received from the arrays, any estimated S-wave arrival times that can be identified, i.e., the processor “picks” any S-wave arrival times that can be picked. In other words, for each of the arrays, the processor analyzes the seismograms received from the array so ascertain whether wavefront 28 reached the array, and if so, estimates the time at which wavefront 28 reached one of the sensors of the array or the average time at which wavefront 28 reached the sensors of the array. (By way of explanation, it is noted that, typically, due to noise from the propagating P wave, an S-wave arrival time cannot be estimated for a sensor that does not belong to an array. On the other hand, the seismograms for an array may be combined, e.g., as described below, so as to overcome the noise, thereby facilitating the S-wave picking for the array.)

In some embodiments, this analysis is performed for each array as follows:
First, for each j^{th} sensor in the array, j=1 . . . N, where N is the number of sensors in the array, the processor calculates the horizontal magnitude of the seismogram recorded by the sensor, i.e., the processor calculates yⱼ^{h}(t)=\sqrt{yⱼ^{e}(t)²+yⱼⁿ(t)²}. Next, the processor applies an STA/LTA filter to yⱼ^{h}(t), yielding a filtered signal yⱼ^{h}*(t). Similarly, the processor applies an STA/LTA filter to the vertical magnitude of the seismogram (i.e., |yⱼ^{v}(t)|), yielding a filtered signal yⱼ^{v}*(t).
Additionally, for each j^{th} sensor in the array, j=1 . . . N, the processor calculates an expected inter-sensor S-wave delay with respect to the first sensor of the array, i.e., the expected difference Δt₁ⱼ^{S} between the S-wave arrival time at the j^{th} sensor and the S-wave arrival time at the first sensor. (The first sensor may be the same as for the computation of the back azimuth, or any other sensor may be designated as the first sensor; in any case, by definition, Δt₁₁^{S}=0.) Typically, Δt₁ⱼ^{S}=γΔt₁ⱼ^{P}, where γ is the ratio of the P-wave speed to the S-wave speed.
Next, the processor computes a horizontal beam B^{h}(t)=Σⱼ₌₁^{N}γⱼ^{h}*(t+Δt₁ⱼ^{S}), which is the sum of the individual filtered signals shifted by the expected inter-sensor delays. The processor further computes a horizontal-to-vertical-ratio beam

$${B}^{h 2 v} ( t ) = \frac{1}{N} {\sum }_{j = 1}^{N} \frac{{y}_{j}^{h *} ( t + Δ {t}_{1 j}^{S} )}{{y}_{j}^{v *} ( t + Δ {t}_{1 j}^{S} )} .$$

(Typically, for efficiency, B^{h}(t) and B^{h2v}(t) are not recalculated after every new seismogram data point is received; for example, the beams may be recalculated after every 10 data points are received.) The processor then checks whether there is any time at which B^{h}(t) and B^{h2v}(t) exceed respective thresholds, such as, for example, 2.5 for B^{h} and 1.5 for B^{h2v}. If so, the processor identifies the estimated S-wave arrival time for the array in response to a time at which B^{h}(t) and B^{h2v}(t) exceed the respective thresholds.
In particular, in some embodiments, the processor identifies the estimated S-wave arrival time as a time at which B^{h}(t) and B^{h2v}(t) exceed (e.g., the time at which B^{h}(t) and B^{h2v}(t) first exceed) the respective thresholds. In other embodiments, based on the time at which B^{h}(t) and B^{h2v}(t) exceed the respective thresholds and on Δt₁ⱼ^{S} for j=2 . . . N, the processor calculates the average S-wave arrival time for the array, and identifies the estimated S-wave arrival time as this average. In other words, by applying the inter-sensor S-wave delays to the S-wave arrival time for the first sensor, the processor calculates the S-wave arrival times for the other sensors. The processor then calculates the average of the N S-wave arrival times.

Notwithstanding the sequential ordering of the steps described above, it is noted that the parameters for each virtual array may be computed in any suitable order. Moreover, one or more parameters for a virtual array may be computed even before all the virtual arrays are defined, i.e., the parameters may be computed in parallel to first step 76.

As noted above, after identifying the estimated S-wave arrival times, or if this step is omitted, the processor computes the estimated coordinates at coordinate-computing step 86. This computation is based on the estimated P-wave arrival times, the back azimuths, and, optionally, the respective slowness magnitudes and/or estimated S-wave arrival times. For example, the processor may compute the estimated coordinates by minimizing a cost function that is based on the aforementioned parameters. For example, to compute the estimated coordinates of the focus, the processor may iterate through K candidate 3D coordinates 52, and for each k^{th} candidate, k=1 . . . K, compute the value of the cost function. After iterating through the candidate coordinates, the processor may select, for estimated coordinates 50, the candidate for which the cost function is a minimum.

For example, in some embodiments, the processor minimizes costₖ=costₖ(t^{P})+costₖ(BAz), where costₖ(t^{P}) is a component of the cost function based on the P-wave arrival times, and costₖ(BAz) is another component based on the back azimuths.

In some such embodiments,

$${cost}_{k} ( {t}^{P} ) = \frac{1}{{σ}_{P}} {\sum }_{j = 1}^{M + O} \vert c {al}_{k}^{j} ( {t}^{P} ) - e s {t}^{j} ( {t}^{P} ) \vert ,$$

where:
M is the number of virtual arrays,
O is the number of lone triggered sensors, which do not belong to a virtual array,
j is an index pointing either to a virtual array or to a lone triggered sensor,
σ_{P} is a predetermined constant representing an uncertainty in the P-wave picking, which may be, for example, between 0.01 and 0.2 s (e.g., 0.05 s),
est^{j}(t^{P}) is the estimated P-wave arrival time for a lone triggered sensor, or the average estimated P-wave arrival time for a virtual array, and
calₖ^{j}(t^{P}) is a calculated P-wave arrival time for a lone triggered sensor, or a calculated average estimated P-wave arrival time for a virtual array, assuming the focus is at the k^{th} candidate coordinates. The calculation of calₖ^{j}(t^{P}) may use any suitable seismic model.

Alternatively or additionally,

$${cost}_{k} ( BAz ) = \frac{1}{{σ}_{B A z}} {{\sum }_{j = 1}}^{M} \begin{matrix}\vert ca {l}_{k}^{j} ( B A z ) - e s {t}^{j} ( B A z ) + 2 π \vert , if c {al}_{k}^{j} ( B A z ) - e s {t}^{j} ( BAz ) < - π \\ \vert c {al}_{k}^{j} ( B A z ) - e s {t}^{j} ( B A z ) - 2 π \vert , if c {al}_{k}^{j} ( B A z ) - e s {t}^{j} ( B A z ) > π \\ \vert c {al}_{k}^{j} ( B A z ) - e s {t}^{j} ( B Az ) \vert , else\end{matrix}$$

where:
M is the number of virtual arrays,
σ_{BAz} is a predetermined constant representing an uncertainty in the BAz estimate, which may be, for example, between 4 and 10 degrees (e.g., 5 degrees),
est^{j}(BAz) is the back azimuth, computed from the estimated P-wave arrival times, for the j^{th} virtual array, and
calₖ^{j}(BAz) is a calculated back azimuth for a vector pointing from the centroid of the j^{th} virtual array in the direction of the k^{th} candidate coordinates.

For embodiments in which the processor computes the respective magnitudes of the slowness vectors, costₖ typically includes an additional component costₖ (SLO), i.e., the processor finds the coordinates that minimize costₖ=costₖ(t^{P})+costₖ(BAz)+costₖ(SLO). In some such embodiments,

$${cost}_{k} ( SLO ) = \frac{1}{{σ}_{S L O}} {\sum }_{j = 1}^{M} \vert c {al}_{k}^{j} ( S L O ) - e s {t}^{j} ( SLO ) \vert ,$$

where:
M is the number of virtual arrays,
σ_{SLO} is a predetermined constant representing an uncertainty in the slowness estimate, which may be, for example, between 0.015 and 0.025 s/km (e.g., 0.02 s/km),
est^{j}(SLO) is the magnitude of the slowness vector, computed from the estimated P-wave arrival times, for the j^{th} virtual array, and
calₖ^{j}(SLO) is a slowness calculated for the j^{th} virtual array, using any suitable seismic model, assuming the focus is at the k^{th} candidate coordinates.

Alternatively or additionally, for embodiments in which the processor computes the estimated S-wave arrival times, costₖ typically includes an additional component costₖ(t^{S}), where t^{S} represents, for any given array, the S-wave arrival time for the first sensor in the array or the average S-wave arrival time for the array. In other words, the processor finds the coordinates that minimize costₖ=costₖ(t)+costₖ(BAz)+costₖ(t^{S}) or costₖ=costₖ(t)+costₖ(BAz)+costₖ(t^{S})+costₖ(SLO). In some such embodiments,

$${cost}_{k} ( {t}^{S} ) = \frac{1}{{σ}_{{t}^{S}}} {\sum }_{j = 1}^{{M}^{′}} \vert c {al}_{k}^{j} ( {t}^{S} ) - e s {t}^{j} ( {t}^{S} ) \vert ,$$

where:
M′ is the number of virtual arrays for which an S-wave arrival time was estimated,
σₜ_{^{S}} is a predetermined constant representing an uncertainty in the S-wave arrival-time estimate, which may be, for example, between 0.1 and 0.4 s (e.g., 0.25 s),
est^{j}(t^{S}) is the estimated S-wave arrival time for the j^{th} virtual array for which this estimate was made, and
calₖ^{j}(t^{S}) is an S-wave arrival time calculated for the j^{th} virtual array, using any suitable seismic model, assuming the focus is at the k^{th} candidate coordinates.

Finally, at an outputting step 88, the processor outputs an output based on coordinates 50. For example, for embodiments in which processor 38 belongs to server cluster 40, the processor may communicate the coordinates, over Internet 44, to another processor belonging to alert center 42. The latter processor may then predict the shaking intensity at one or more target sites based on coordinates 50, and communicate one or more alerts responsively thereto. Similarly, for embodiments in which processor 38 belongs to alert center 42, processor 38 may predict the shaking intensity at one or more target sites based on coordinates 50, and communicate one or more alerts responsively thereto.

Typically, processor 38 identifies the estimated P-wave arrival times during the seismic disturbance, i.e., while wavefront 26, or at least wavefront 28, is still propagating. In some embodiments, the processor also defines at least one of the virtual arrays before one or more of the estimated P-wave arrival times. For example, the processor may define one or more virtual arrays including those of the sensors that are closer to shore, before wavefront 26 reaches those of the sensors that are further inland. In some embodiments, the processor also estimates coordinates 50 during the seismic disturbance. Advantageously, these real-time computations facilitate the output of an early alert, such as an early earthquake warning, from alert center 42.

### Defining the Virtual Arrays

Reference is now made to FIG. 3, which is a flow diagram for an example algorithm for defining virtual arrays 46, which may be executed by processor 38 as first step 76 of method 54, in accordance with some embodiments of the present invention.

At a checking step 56, the processor continually checks, for each received seismogram, whether an estimated P-wave arrival time can be identified—i.e., whether a P-wave arrival time can be picked—based on the seismogram. Upon picking a P-wave arrival time (and thus triggering the sensor), the processor checks, at another checking step 58, whether at least one extendible array is defined. An extendible array is an array in which the number of seismic sensors is at least three but is less than a predefined number Nₘₐₓ, which may be four or five, for example.

If at least one extendible array is defined, the processor, at an evaluating step 60, evaluates one or more constraints for each of the extendible arrays, assuming the newly-triggered sensor is added to the array. These constraints are described below.

Next, at another checking step 62, the processor checks whether the constraints are satisfied for at least one of the extendible arrays with the addition of the newly-triggered sensor. If yes, the processor, at an array-extending step 64, adds the newly-triggered sensor to the “best” array, which is typically the array for which the constraints are best-satisfied following the addition of the sensor. The processor then returns to checking step 56.

Alternatively, if no extendible arrays are defined, or if the constraints are not satisfied for any of the extendible arrays, the processor adds the newly-triggered sensor to a waitlist, at a waitlisting step 68. The processor then checks, at another checking step 70, whether at least one virtual array can be constructed from the waitlist, i.e., whether at least three of the sensors in the waitlist can be combined in a virtual array. For example, for each candidate virtual array of three or more sensors, the processor may check whether the aforementioned constraints are satisfied. If at least one virtual array can be constructed, the processor, at an array-constructing step 72, constructs the best array, which is typically the array for which the constraints are best satisfied.

In general, a back azimuth for a single virtual array, together with at least one estimated P-wave arrival time for a sensor not belonging to the virtual array, is sufficient for computing estimated coordinates 50. Typically, however, for greater accuracy, the processor uses multiple back azimuths. For example, the processor may refrain from computing the estimated coordinates until a predefined maximum number Mₘₐₓ of virtual arrays have been defined (and the corresponding Mₘₐₓ back azimuths have computed), where Mₘₐₓ is greater than one, e.g., greater than five, ten, fifteen, or twenty. In response to defining Mₘₐₓ virtual arrays (and computing the corresponding Mₘₐₓ back azimuths), the processor computes estimated coordinates 50.

Thus, following array-constructing step 72, the processor checks, at another checking step 66, whether Mₘₐₓ virtual arrays have been defined. If yes, the execution of the algorithm ends; otherwise, the processor returns to checking step 56.

Alternatively, any other suitable algorithm is used to construct the virtual arrays. For example, an alternate algorithm may add the newly-triggered sensor to the first array for which the constraints are satisfied, and/or construct, from the waitlist, the first array for which the constraints are satisfied, rather than searching for the best array. Alternatively or additionally, a single sensor may be allowed to belong to multiple virtual arrays.

### Constraints on Virtual Arrays

In some embodiments, the constraints on each virtual array include a stability constraint, which requires that the solution to an equation for calculating the slowness vector s based on the respective P-wave arrival times for the seismic sensors in the virtual array have a predefined degree of stability.

For example, as described above with reference to FIGS. 1-2, the processor may solve the equation \vec{s}=(X^{T}X)⁻¹X^{T}\vec{Δₜ^{P}}. This solution has relatively little stability if small changes in the estimated P-wave arrival times lead to large changes in s, which is generally the case if the sensors are relatively colinear. Hence, the stability constraint may require that that a stability index, defined as

$$( \frac{{λ}_{2}}{{λ}_{1}} ) ,$$

exceed a predefined threshold, where λ₁ and λ₂ are largest and smallest eigenvalues of X^{T}X, respectively. For example, FIG. 1 shows a hypothetical virtual array 46h1 in which the sensors are relatively colinear. The processor may refrain from defining this array, due to the stability index not exceeding the threshold.

In some embodiments, the threshold for the stability index is between 0.7 and 0.9. (By definition, the stability index ranges between 0 and 1.) Advantageously, the stability index is applicable even to arrays including more than three sensors.

Alternatively or additionally, the constraints on each virtual array include an inter-sensor delay constraint, which requires that Δtᵢⱼ<rᵢⱼ/α, where rᵢⱼ=\sqrt{(xᵢⱼ^{e})²+(xᵢⱼⁿ)²} and α is the upper-crust P-wave speed (approximately 5.55 km/s) for all i≠j, i=1 . . . N and j=1 . . . N. This constraint effectively requires that each pair of sensors in the array detect the same seismic event.

Alternatively or additionally, the constraints on each virtual array include an external-location constraint, which requires that preliminary estimated coordinates of a point on the Earth's surface above the focus, which the processor estimates based on the respective estimated P-wave arrival times for the seismic sensors in the virtual array, lie outside the perimeter of the virtual array. (Such a constraint justifies using the array-based location techniques described herein.) The perimeter may be defined, for example, as the perimeter of the smallest convex polygon that encloses all the sensors in the array. Typically, to estimate the preliminary coordinates, the processor computes a cost for each one of multiple candidate coordinates, and then selects the candidate coordinates for which the cost is minimized. In some embodiments, the minimized cost function, for each k^{th} candidate, is Σⱼ₌₁^{N}|calₖ^{j}(t^{P})−est^{j}(t^{P})|, where:
N is the number of sensors in the array,
est^{j}(t^{P}) is the estimated P-wave arrival time for the j^{th} sensor in the array, and
calₖ^{j}(t^{P}) is a P-wave arrival time calculated, using any suitable seismic model, for the j^{th} sensor, assuming the focus is beneath the k^{th} candidate coordinates.

For example, FIG. 1 shows another hypothetical virtual array 46h2 and hypothetical estimated coordinates 22h of a surface point above the focus of another seismic disturbance. Given that coordinates 22h are within the perimeter of virtual array 46h2, the processor may refrain from defining array 46h2, based on the external-location constraint.

As described above with reference to FIG. 3, in some embodiments, array-extending step 64 and array-constructing step 72 depend on identifying an array for which the constraints are best satisfied. In some embodiments, this “best” array is the array having the highest stability index. Alternatively or additionally, the identification of the best array takes other constraints into account.

It is noted that the scope of the present invention includes computing estimated coordinates 50 (FIG. 1), e.g., by minimizing a cost function as described above, based on the estimated P-wave arrival times, back azimuths, estimated S-wave arrival times, and, optionally, the magnitudes of the slowness vectors, regardless of whether the arrays of seismic sensors are virtual or conventional.

Embodiments of the invention described herein can take the form of a computer program product accessible from a computer-usable or computer-readable medium (e.g., a non-transitory computer-readable medium) providing program code for use by or in connection with a computer or any instruction execution system. For the purpose of this description, a computer-usable or computer readable medium can be any apparatus that can comprise, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Typically, the computer-usable or computer readable medium is a non-transitory computer-usable or computer readable medium.

Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W), DVD, and a USB drive.

Computer program code for carrying out operations of the present invention may be written in any combination of one or more programming languages, including an object-oriented programming language such as Java, Smalltalk, C++ or the like and conventional procedural programming languages, such as the C programming language or similar programming languages.

In some embodiments, processor 38 (FIG. 1) is coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. The processor can read the inventive instructions on the program storage devices and follow these instructions to execute the methodology of the embodiments of the invention.

Network adapters may be coupled to the processor to enable the processor to become coupled to other processors or remote printers or storage devices through intervening private or public networks. Modems, cable modem and Ethernet cards are just a few of the currently available types of network adapters.

It will be appreciated by persons skilled in the art that the present invention is not limited to what has been particularly shown and described hereinabove. Rather, the scope of the present invention includes both combinations and subcombinations of the various features described hereinabove, as well as variations and modifications thereof that are not in the prior art, which would occur to persons skilled in the art upon reading the foregoing description.

1. A system, comprising:
multiple seismic sensors; and
a processor, configured to:
receive respective seismograms from the seismic sensors during a seismic disturbance,
identify, based on the seismograms, respective estimated P-wave arrival times for at least some of the seismic sensors,
based on the estimated P-wave arrival times, define one or more virtual arrays, each of which includes at least three of the seismic sensors, compute respective back azimuths for the virtual arrays,
based on the estimated P-wave arrival times and back azimuths, compute estimated coordinates of a focus of the seismic disturbance or of a point on a surface of Earth above the focus, and
output an output based on the coordinates.

2. The system according to claim 1, wherein the seismic disturbance is an earthquake, and wherein the focus is a hypocenter of the earthquake.

3. The system according to claim 1, wherein the processor is configured to define at least one of the virtual arrays before one or more of the estimated P-wave arrival times.

4. The system according to claim 1, wherein the processor is configured to compute the estimated coordinates in response to defining a predefined maximum number of the virtual arrays, the maximum number being greater than one.

5. The system according to claim 1, wherein the processor is configured to compute the estimated coordinates by minimizing a cost function that is based on the estimated P-wave arrival times and back azimuths.

6. The system according to claim 1, wherein the processor is further configured to compute respective slowness vectors for the virtual arrays based on the estimated P-wave arrival times, and wherein the processor is configured to compute the back azimuths based on the slowness vectors.

7. The system according to claim 6, wherein the processor is configured to compute the estimated coordinates based on respective magnitudes of the slowness vectors.

8. The system according to claim 1, wherein the processor is further configured to identify, based on the seismograms, respective estimated S-wave arrival times for at least some of the virtual arrays, and wherein the processor is configured to compute the estimated coordinates based on the estimated S-wave arrival times.

9. The system according to claim 1, wherein the processor is configured to define the virtual arrays such that, for each of the virtual arrays, the respective estimated P-wave arrival times for the seismic sensors in the virtual array satisfy multiple constraints.

10. The system according to claim 9, wherein the constraints include a stability constraint, which requires that a solution to an equation for calculating a slowness vector based on the respective estimated P-wave arrival times for the seismic sensors in the virtual array have a predefined degree of stability.

11-13. (canceled)

14. The system according to claim 9, wherein the constraints include an external-location constraint, which requires that preliminary estimated coordinates of the point above the focus, which are estimated based on the respective estimated P-wave arrival times for the seismic sensors in the virtual array, lie outside a perimeter of the virtual array.

15. A method, comprising:
receiving multiple seismograms from respective seismic sensors during a seismic disturbance;
identifying, based on the seismograms, respective estimated P-wave arrival times for at least some of the seismic sensors;
based on the estimated P-wave arrival times, defining one or more virtual arrays, each of which includes at least three of the seismic sensors;
computing respective back azimuths for the virtual arrays;
based on the estimated P-wave arrival times and back azimuths, computing estimated coordinates of a focus of the seismic disturbance or of a point on a surface of Earth above the focus; and
outputting an output based on the coordinates.

16. The method according to claim 15, wherein the seismic disturbance is an earthquake, and wherein the focus is a hypocenter of the earthquake.

17. The method according to claim 15, wherein defining the virtual arrays comprises defining at least one of the virtual arrays before one or more of the estimated P-wave arrival times.

18. The method according to claim 15, wherein computing the estimated coordinates comprises computing the estimated coordinates in response to defining a predefined maximum number of the virtual arrays, the maximum number being greater than one.

19. The method according to claim 15, wherein computing the estimated coordinates comprises computing the estimated coordinates by minimizing a cost function that is based on the estimated P-wave arrival times and back azimuths.

20. The method according to claim 15, further comprising computing respective slowness vectors for the virtual arrays based on the estimated P-wave arrival times, wherein computing the back azimuths comprises computing the back azimuths based on the slowness vectors.

21. The method according to claim 20, wherein computing the estimated coordinates comprises computing the estimated coordinates based on respective magnitudes of the slowness vectors.

22. The method according to claim 15, further comprising identifying, based on the seismograms, respective estimated S-wave arrival times for at least some of the virtual arrays, wherein computing the estimated coordinates comprises computing the estimated coordinates based on the estimated S-wave arrival times.

23. The method according to claim 15, wherein defining the virtual arrays comprises defining the virtual arrays such that, for each of the virtual arrays, the respective estimated P-wave arrival times for the seismic sensors in the virtual array satisfy multiple constraints.

24. The method according to claim 23, wherein the constraints include a stability constraint, which requires that a solution to an equation for calculating a slowness vector based on the respective estimated P-wave arrival times for the seismic sensors in the virtual array have a predefined degree of stability.

25-27. (canceled)

28. The method according to claim 23, wherein the constraints include an external-location constraint, which requires that preliminary estimated coordinates of the point above the focus, which are estimated based on the respective estimated P-wave arrival times for the seismic sensors in the virtual array, lie outside a perimeter of the virtual array.

29. A computer software product comprising a tangible non-transitory computer-readable medium in which program instructions are stored, which instructions, when read by a processor, cause the processor to:
receive multiple seismograms from respective seismic sensors during a seismic disturbance,
identify, based on the seismograms, respective estimated P-wave arrival times for at least some of the seismic sensors,
based on the estimated P-wave arrival times, define one or more virtual arrays, each of which includes at least three of the seismic sensors,
compute respective back azimuths for the virtual arrays,
based on the estimated P-wave arrival times and back azimuths, compute estimated coordinates of a focus of the seismic disturbance or of a point on a surface of Earth above the focus, and
output an output based on the coordinates.

30. A system, comprising:
multiple seismic sensors; and
a processor, configured to:
receive respective seismograms from the seismic sensors during a seismic disturbance,
identify, based on the seismograms, respective estimated P-wave arrival times for at least some of the seismic sensors,
based on the estimated P-wave arrival times, compute respective back azimuths for one or more arrays of the seismic sensors,
identify, based on the seismograms, respective estimated S-wave arrival times for at least some of the arrays,
based on the estimated P-wave arrival times, back azimuths, and
estimated S-wave arrival times, compute estimated coordinates of a focus of the seismic disturbance or of a point on a surface of Earth above the focus, and
output an output based on the coordinates.

31-46. (canceled)
